(19) United States
(12) Patent Application Publication
(10) Pub. No.: US 2007/0172735 A1
(43) Pub. Date: Jul. 26, 2007

(54) Thin-film Battery

(75) Inventors: David R. Hall, Provo, UT (US); Scott Dahlgren, Alpine, UT (US)

Correspondence Address: TYSON J. WILDE;NOVATEK INTERNATIONAL, INC., 2185 SOUTH LARSEN PARKWAY, PROVO, UT, 84606, US

(73) Assignee: David R. Hall, Provo, UT (US)

(21) Appl. No.: 11/307,196

(22) Filed: Jan. 26, 2006

(51) Int. Cl. H01M 4/70; H01M 4/04

(52) U.S. Cl. 429/233; 29/623.5

(57) ABSTRACT

A battery has a cathode layer deposited on a first current collector layer, an anode layer, and a solid-state electrolyte layer between the cathode layer and the anode layer. The cathode layer has a first projection and the anode layer has a second projection. The solid-state electrolyte layer has a first recess complementary to the first projection and a second recess complementary to the second projection. The battery also has a second current collector layer deposited over the anode layer.

### BACKGROUND OF THE INVENTION

The present invention is related to batteries, and more particularly to thin-film batteries.

Thin-film batteries are defined generally as batteries that have been created by the deposition of multiple layers (each layer being typically up to 4 microns thick) of solid-state components on a substrate to create a battery. In the art it is common to use a lithium anode in conjunction with a lithium intercalation compound cathode separated by a solid-state electrolyte such as lithium phosphorus oxynitride (“LiPON”).

Thin-film batteries provide many desirable features and are versatile in their applications. One of these desirable features is the ability of the thin-film batteries to perform at high temperatures. Many conventional battery designs today employ electrolytes made of liquid, paste, or gel to separate the cathode from the anode. In high temperature environments, these electrolytes may boil, evaporate, expand, and/or spill—yielding adverse and often irreversible repercussions to the battery's performance. However, thin-film batteries are made completely out of solid-state components and may function properly at much higher temperatures—making them ideal for use in downhole and aeronautical environments, among others. Other desirable features of thin-film batteries include their conveniently small size, the possibility of manufacturing the batteries on a flexible substrate, and their rechargability.

Much thin-film battery art exists in the industry. U.S. Pat. No. 5,569,520 to Bates, herein incorporated by reference for all it discloses, teaches of the use of a relatively thick cathode of a lithium intercalation compound and a relatively thick anode of lithium in conjunction with an electrolyte film to supply low to high power output.

U.S. Pat. No. 6,517,968 to Johnson, herein incorporated by reference for all it discloses, teaches of a rechargeable, thin film lithium battery cell having an aluminum cathode current collector having a transition metal sandwiched between two crystallized cathodes.

### SUMMARY OF THE INVENTION

In one aspect of the invention, a battery has a cathode layer deposited on a first current collector layer. The first current collector layer may comprise aluminum, gold, nickel, copper, or another suitable conductor material. The battery also has an anode layer, and a solid-state electrolyte layer between the cathode layer and the anode layer. The cathode layer has a first projection and the anode layer has a second projection. The solid-state electrolyte layer has a first recess complementary to the first projection and a second recess complementary to the second projection.

The cathode layer preferably has a plurality of projections with complementary recesses in the solid-state electrolyte layer. The anode may also have a plurality of projections with complementary recesses in the solid-state electrolyte layer. The battery also has a second current collector layer deposited over the anode layer. The solid-state electrolyte layer may be lithium phosphorus oxynitride (“LiPON”). The battery is preferably rechargeable.

In accordance with another aspect of the invention, a method of fabricating a battery includes the following steps: providing a first current collector; depositing a cathode layer comprising a first projection on the first current collector; depositing an electrolyte layer over the cathode layer, the electrolyte layer having a first recess complementary to the first projection; depositing an anode layer over the electrolyte layer, the anode layer having a second projection complementary to a second recess in the electrolyte layer, and depositing a second current collector layer over the anode layer.

At least one of the layers may be deposited by three-dimensional printing. Additionally, the method may include the step of annealing the cathode layer. This may occur in-situ as the cathode layer is deposited. At least one of the layers may be cured. In the cathode and anode layers, a plurality of projections with complementary recesses in the electrolyte layer may be deposited. A protective coating may be deposited over the second current collector and exposed portions of other layers.

In another aspect of the invention, a system incorporates the disclosed battery in a downhole device disposed within a bore extending into a portion of the earth. The downhole device may be coupled to a tool string.

### BRIEF DESCRIPTION OF THE DRAWINGS

FIG. 1A is a cross-sectional diagram of one embodiment of a battery.

FIG. 1B is a cross-sectional perspective diagram of the embodiment of FIG. 1A.

FIG. 1C is a cross-sectional perspective diagram of a cathode layer of the embodiment of FIGS. 1A-B.

FIG. 2A is a cross-sectional diagram of one embodiment of a battery.

FIG. 2B is a cross-sectional perspective diagram of the embodiment of FIG. 2A.

FIG. 2C is a cross-sectional perspective diagram of a cathode layer of the embodiment of FIGS. 2A-B.

FIG. 3A is a cross-sectional diagram of one embodiment of a battery.

FIG. 3B is a cross-sectional perspective diagram of the embodiment of FIG. 3A.

FIG. 3C is a cross-sectional perspective diagram of a cathode layer of the embodiment of FIGS. 3A-B.

FIG. 4A is a cross-sectional diagram of one embodiment of a battery.

FIG. 4B is a cross-sectional perspective diagram of the embodiment of FIG. 4A.

FIG. 4C is a cross-sectional perspective diagram of a cathode layer of the embodiment of FIGS. 4A-B.

FIG. 5 is a cross-sectional diagram of a battery with two cells in a series configuration.

FIG. 6 is a cross-sectional diagram of a battery on a substrate.

FIG. 7 is a cross-sectional diagram of two batteries connected in a series configuration

on a substrate.

FIG. 8 is a perspective diagram of a thin-cell battery.

FIG. 9 is a flowchart illustrating a method of fabricating a battery.

FIG. 10 is a flowchart illustrating a more detailed method of fabricating a battery.

FIG. 11 is a diagram of a downhole drilling rig with a battery-operated downhole tool.

### DETAILED DESCRIPTION OF THE INVENTION AND THE PREFERRED EMBODIMENT

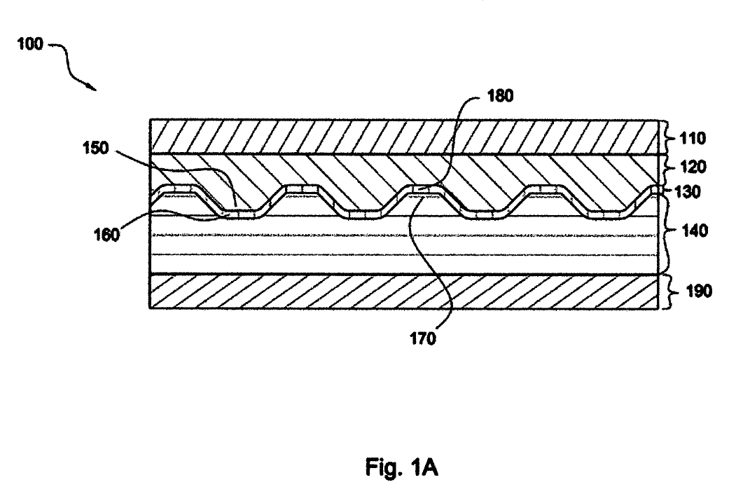

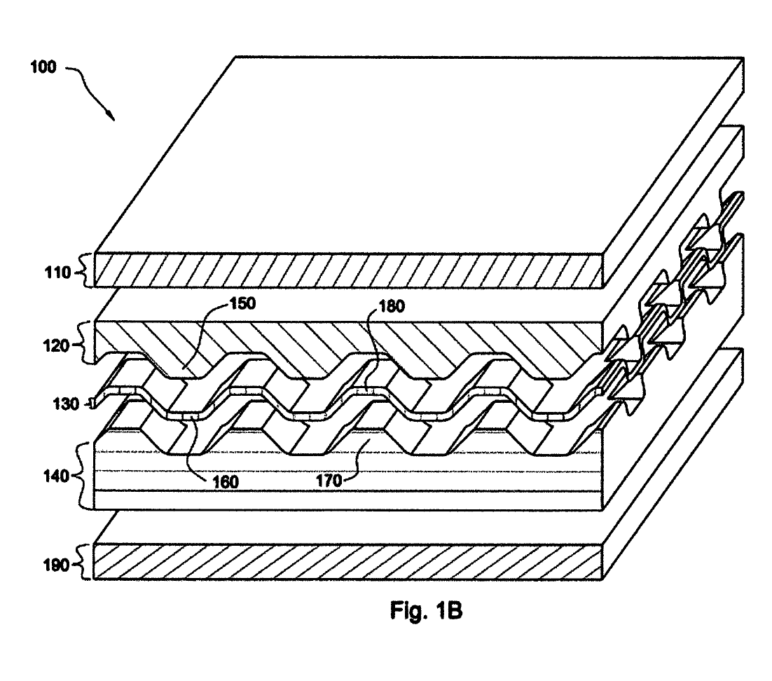

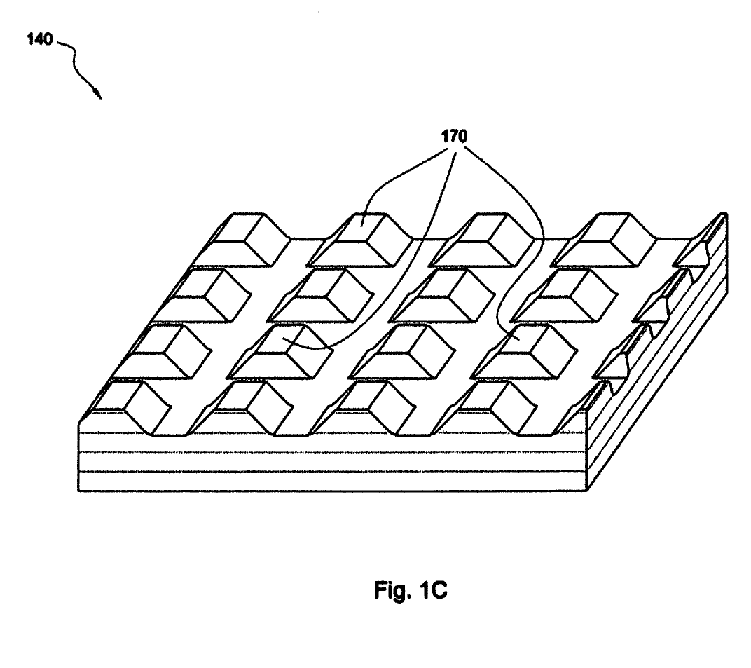

Referring to FIGS. 1A-1C, a thin-film battery 100 comprises various layers 110, 120, 130, 140, 190. FIG. 1A is a cross-sectional diagram of a portion of a battery 100. The battery 100 comprises a first current collector layer 190. A cathode layer 140 is deposited on the first current collector layer 190 and comprises a first projection 170. An anode layer 120 comprises a second projection 150.

A solid-state electrolyte layer 130 is intermediate the cathode layer 140 and the anode layer 120. The solid-state electrolyte layer comprises a first recess 180 complementary to the first projection 170 of the cathode layer 140 and a second recess 160 complementary to the second projection 150 of the anode layer 120.

A second current collector layer 110 is deposited on the anode layer 120. The first and second current collector layers 190, 110 may comprise aluminum. Alternatively, the current collector layers 190, 110 may comprise gold, nickel, copper or another suitable electrical conductor.

In some embodiments, the battery 100 is a lithium battery, and the cathode layer 140 may comprise a lithium intercalation compound such as lithium cobalt oxide (LiₓCoO₂), lithium manganese oxide (LiₓMn₂O₂), lithium nitrogen sulfide (LiₓNiO₂), crystalline titanium sulfide (TiS₂), amorphous vanadium pentoxide (aV₂O₅), vanadium oxide (V₆0₁₃), or other known cathode material(s). In at least one embodiment, the anode layer 120 may comprise lithium metal or tin nitride (Sn₃N₄) and the solid-state electrolyte layer 130 may comprise lithium phosphorus oxynitride (LiₓPo_{y}N_{z} or “LiPON”).

While thin-film batteries known in the art are primarily lithium batteries, the features of the present invention may be applied to any other type of thin-film battery known in the art as well as many yet to be developed.

FIG. 1B is an exploded three-dimensional view of the portion of battery 100 shown in FIG. 1A.

When battery 100 has a stored charge, ions such as lithium ions reside at a relatively high chemical potential in the cathode layer 140 and at a relatively low chemical potential when combined with the material in the anode layer 120. For the ions to move from the higher chemical potential in the cathode layer 140 to the lower chemical potential of the anode layer 120, two requirements must typically be met: first, a physical transport mechanism must exist; secondly, electrons displaced from the anode layer 120 must be transported to the cathode layer 140 where they are accepted by the cathode material.

The solid-state electrolyte layer 130 serves as an effective physical and chemical transport mechanism for the ions to move from the cathode layer 140 to the anode layer 120. However, the solid-state electrolyte layer 130 does not conduct electrons from the anode layer 120 back to the cathode layer 140. As long as the electrons from the anode layer 120 have no effective path to the cathode layer 140 the ions will not move across the solid-state electrolyte layer 130 from the cathode layer 140 to the anode layer 120.

When an electrical path is provided between the cathode layer 140 and the anode layer 120, electrons flow from the anode layer 120 to the cathode layer 140 as ions move from the cathode layer 140 through the solid-state electrolyte layer 130 to the anode layer 120. The flowing electrons provide an electric current between the cathode layer 140 and the anode layer 120 and the battery 100 discharges. Once the supply of ions in the cathode layer 140 is depleted, the battery 100 becomes fully discharged and must be recharged before it is able to supply more electric energy.

The energy storage and current discharge capacity of battery 100, therefore, depend directly on the amount of ions that may be transported from the cathode layer 140 to the anode layer 120 through the solid-state electrolyte layer 130.

One specific characteristic of a thin-film battery 100 that affects the amount of ions that may be transported through the solid-state electrolyte layer 130 is the surface area of the interface between the cathode layer 140 and the solid-state electrolyte layer 130 and the surface area of the interface between the solid-state electrolyte layer 130 and the anode layer 120. As these surface areas increase more ions are able to pass through the solid-state electrolyte layer 130, which increases the amount of electrons that may move from the anode layer 120 to the cathode layer 140. This in turn boosts the capacity of the battery 100.

The surface areas are increased in the invention through the first projection 170 of the cathode layer 140 and the second projection 150 of the anode layer 120, together with corresponding recesses 180, 160 in the solid-state electrolyte layer 130.

FIG. 1C is a three-dimensional perspective view of the cathode layer 140 of the battery 100 shown in FIGS. 1A-1B with other layers removed for clarity. While in some embodiments of the invention the cathode layer 140 and the anode layer 120 may each comprise only a single projection 170, 150 respectively, a plurality of projections 170, 150 in the cathode and anode layers 140, 120 in conjunction with a plurality of complementary recesses 180, 160 in the solid-state electrolyte layer 130 provide an embodiment of the battery 100 with increased current capacity.

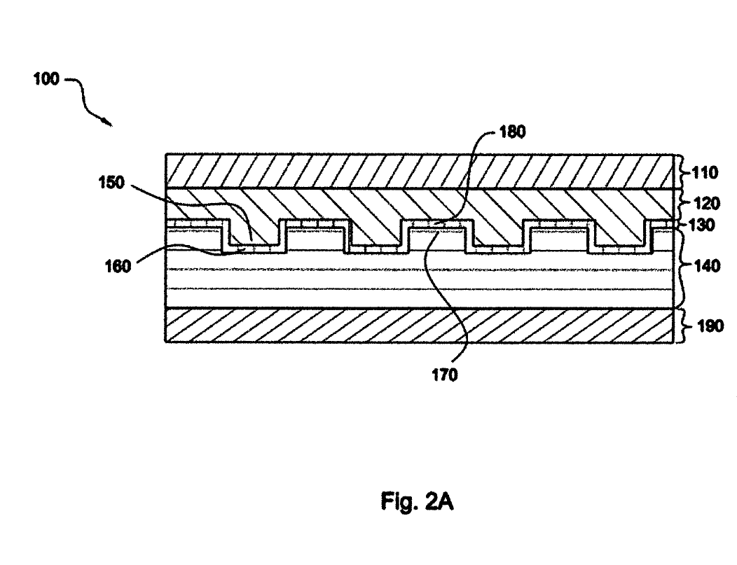

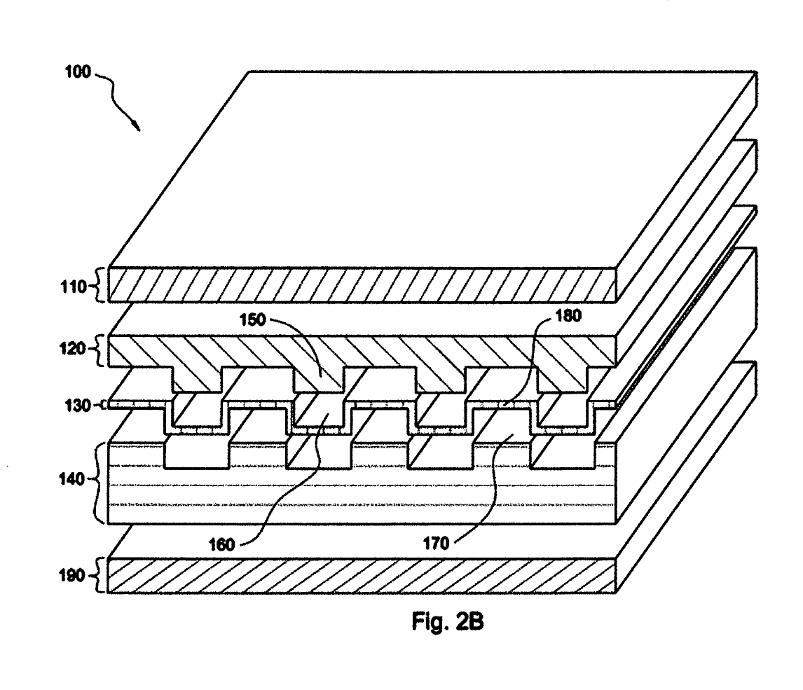

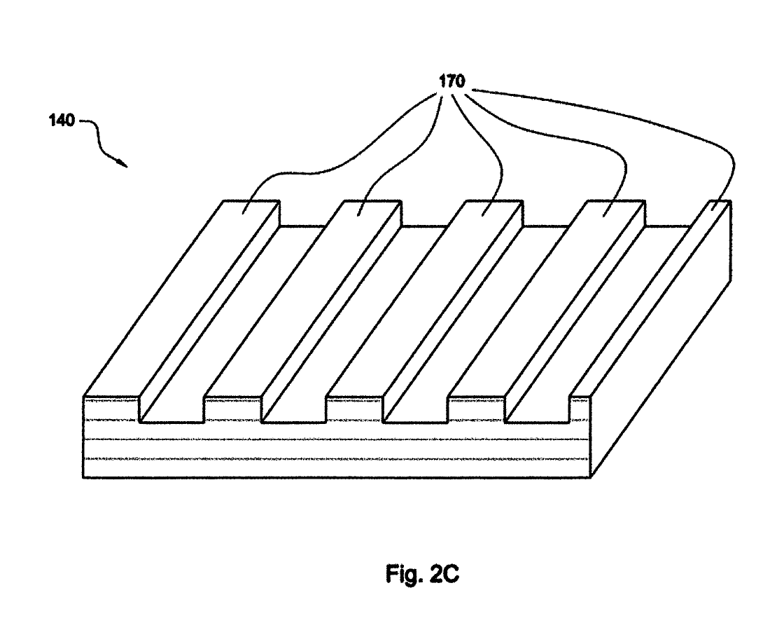

FIGS. 2A-2C illustrate another embodiment of a thin-film battery 100. While the embodiment of FIGS. 1A-1C comprised a cathode layer 140 and an anode layer 120 with several smaller projections 170, 150, it may be beneficial in other embodiments for the cathode layer 140 and/or the anode layer 120 to comprise projections 170, 150 that are fewer in number but larger in size.

The various layers 110, 120, 130, 140, 190 may be created by a variety of means such as three-dimensional printing, stereolithography, rapid prototyping, or standard deposition. Additional processes such as annealing and curing may also be performed on the layers 110, 120, 130, 140, 190 as they are deposited. Because of the variations introduced in manufacturing according to the specific processes used in fabricating the battery 100, it may result that a certain shape or size of projections 170, 150 may be more ideal for a certain fabrication process than others. Still referring to FIGS. 2A-2C, the rectangular projections 170, 150 extending substantially perpendicular to the cathode layer 140 and the anode layer 120 along with their complementary recesses 160, 180 in the solid-state of these figures represent one embodiment of a projection.

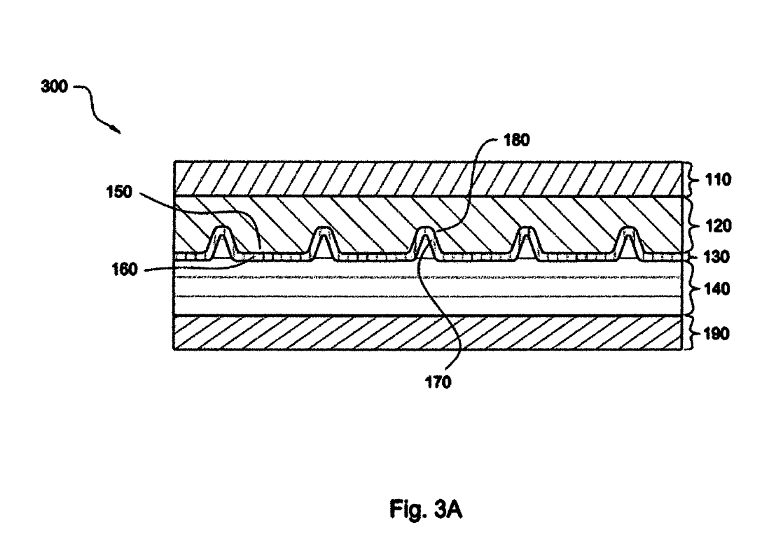

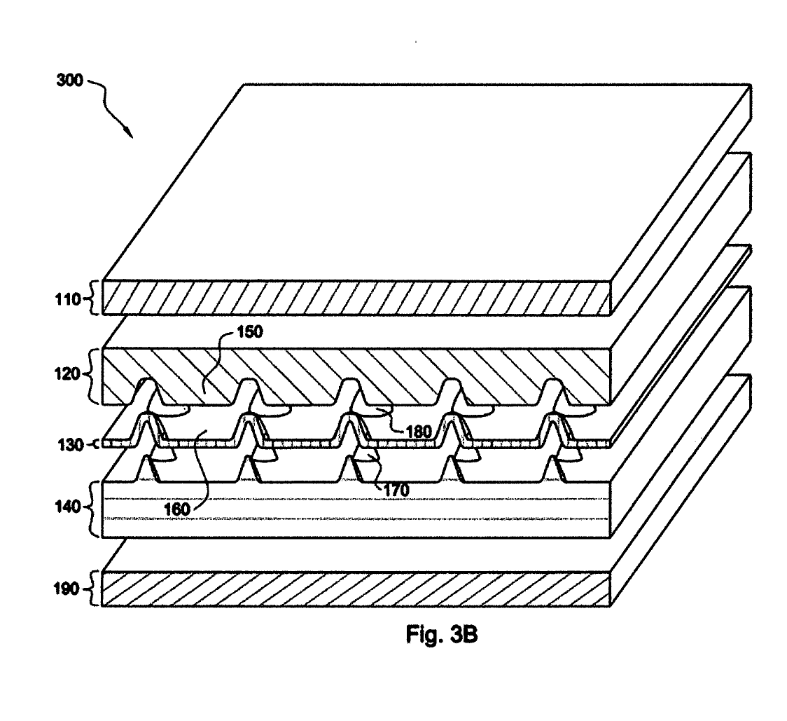

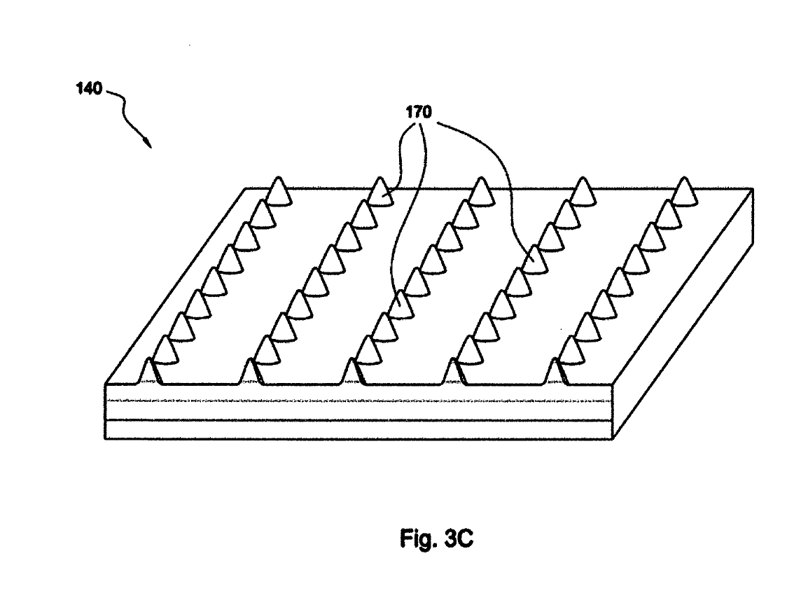

Another embodiment of a shape and configuration of the projections 170, 150 and recesses 160, 180 in the battery 100 are shown in FIGS. 3A-3C. The projections 170, 150 of the cathode and anode layers 140, 120 may be generally conical, frusto-conical, triangular, cubical, sinusoidal, pyramidal, asymmetric or combinations thereof.

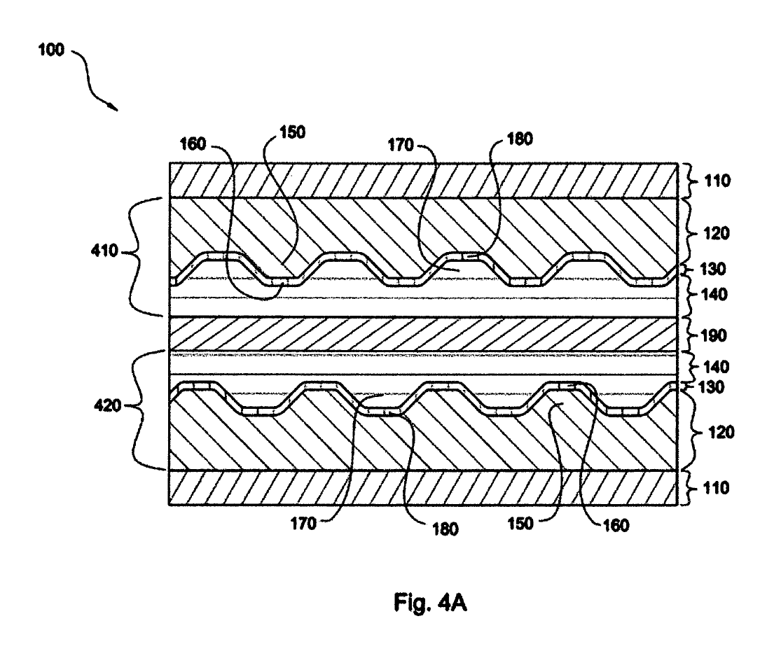

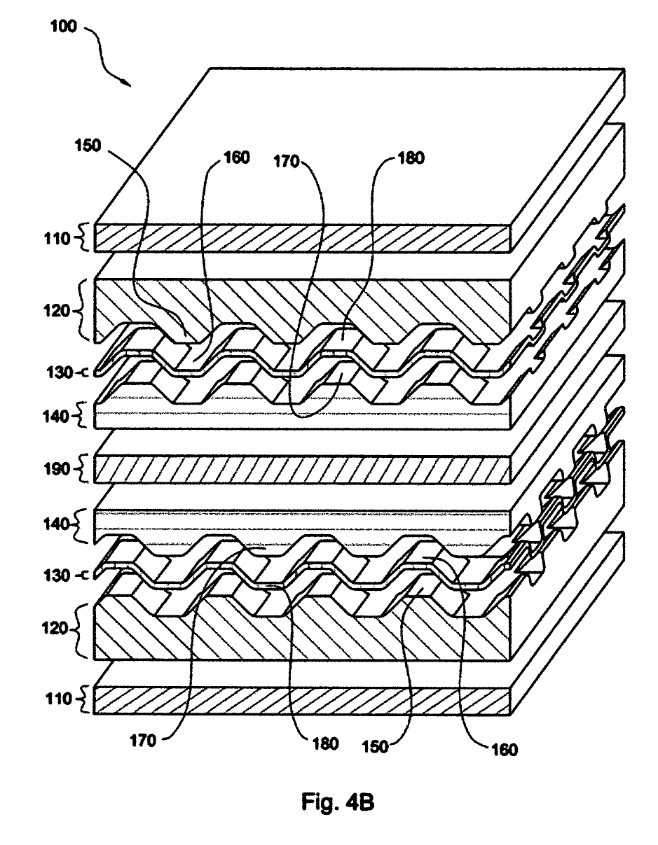

FIGS. 4A-4B depict another embodiment of a thin-film battery 100 comprising a first cell 410 and a second cell 420 in a stacked configuration. Each cell 410, 420 is defined by a cathode layer 140, a solid-state electrolyte layer 130, and an anode layer 120. In a stacked configuration, at least one current collector 110, 180 is shared between at least two cells 410, 420. In this particular embodiment, a separate cathode layer 120 is deposited on each side of the first current collector 110. By electrically connecting a positive terminal to the shared cathode layer 140 and a negative terminal to both anode layers 180, the two individual cells 410, 420 will become effectively connected in a parallel configuration. The parallel configuration of the cells 410, 420 increases the capacity of the battery 100.

It may be particularly effective for thin-film batteries 100 to be in a stacked configuration because the addition of a cell to the battery 100 contributes relatively little volume and may substantially increase battery capacity.

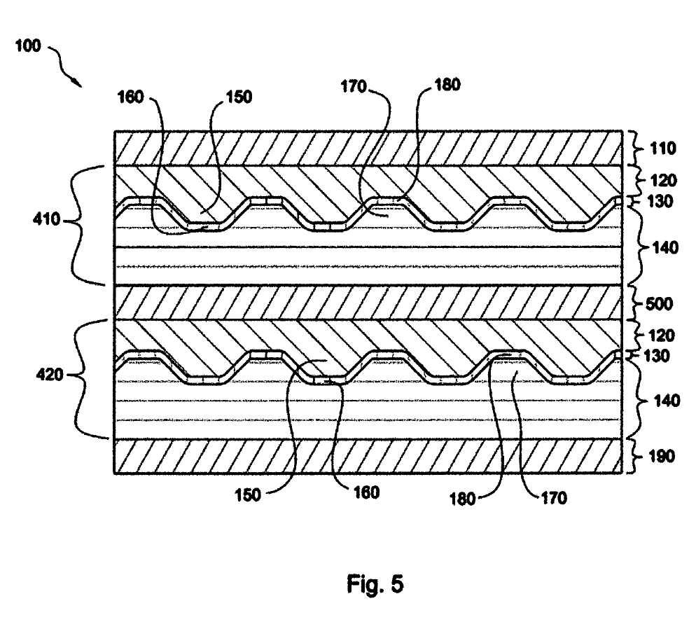

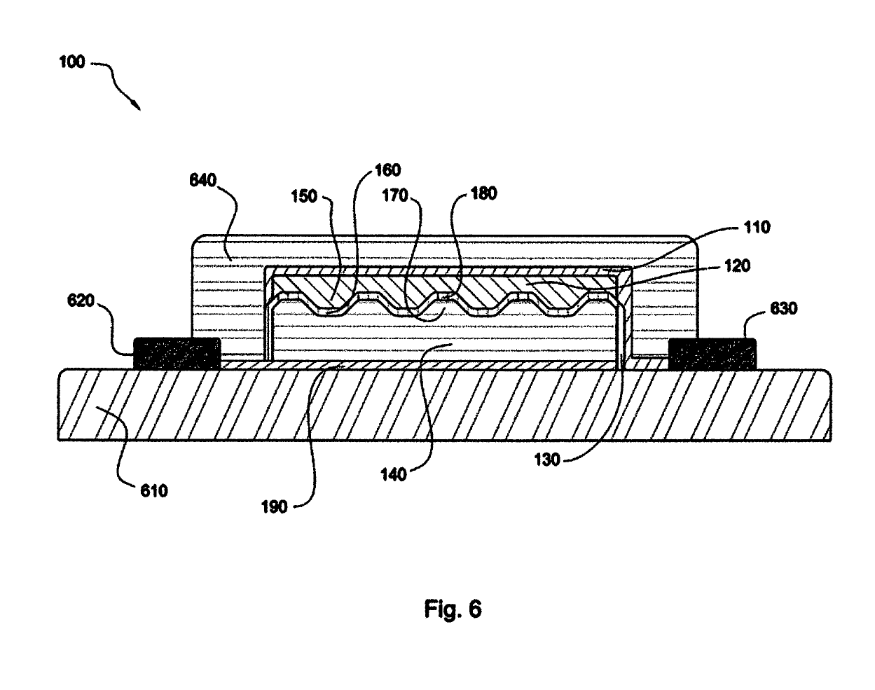

Referring now to FIG. 5, two or more cells 410, 420 of a thin-film battery 100 may be stacked in a series configuration. Instead of each cell 410, 420 comprising its own first current collector 190 layer and second current collector layer 110, a single current collector layer 500 connects the anode layer 120 of the second cell 420 to the cathode layer 140 of the first cell 410. Cells 410, 420 connected in a series configuration may provide a battery 100 with a higher voltage.

While only two cells 410, 420 have been shown in a stacked configuration in FIGS. 4A-B and FIG. 5 for clarity, it should be understood that more than two cells 410, 420 may be stacked in a thin-film battery 100 of the present invention in a parallel or series configuration

Referring now to FIG. 6, a cross-sectional view of a thin-film battery 100 deposited on a substrate 610 is shown. The battery 100 comprises projections 170, 150 in both the cathode layer 140 and the anode layer 120 respectively. Corresponding recesses 180, 150 in the solid-state electrolyte layer 130 are complementary to the projections 170, 150. The first current collector layer 190 may extend beyond the edge of the cathode layer 140 and connect to a positive battery terminal 620. The second current collector layer 110 may be in electrical communication with a negative battery terminal 630.

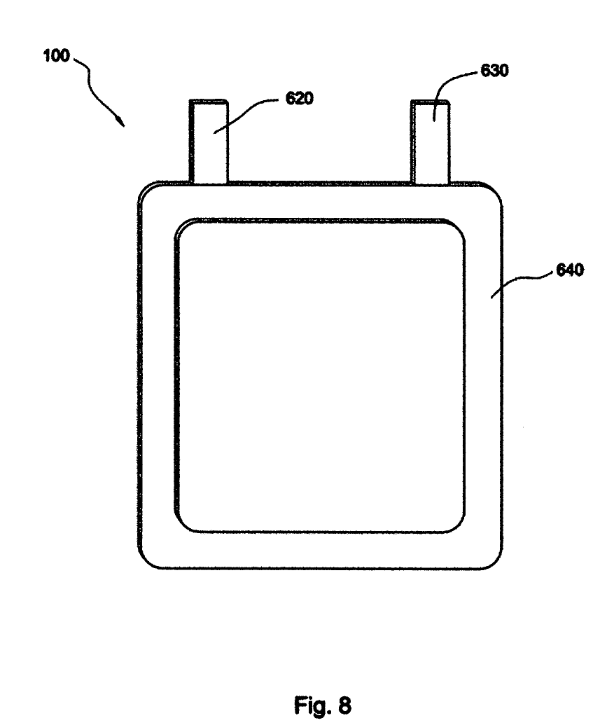

In at least one embodiment, the various layers 110, 120, 130, 140, 190 of the battery 100 may be encapsulated in a protective coating 640 such as parylene or another polymer material. All or part of the battery terminals 620, 630 may extend through the protective coating 640 (see also FIG. 8). The battery terminals 620, 630 may be connected to an electronic device or some other resistive load to harness the energy stored in the battery.

The substrate 610 may be a semiconductor chip comprising other circuit elements fabricated thereon. In at least one embodiment, the substrate may comprise a polymide support substrate similar to what is taught in U.S. Pat. No. 6,835,493 to Zhang et al., which is herein incorporated by reference for all it discloses.

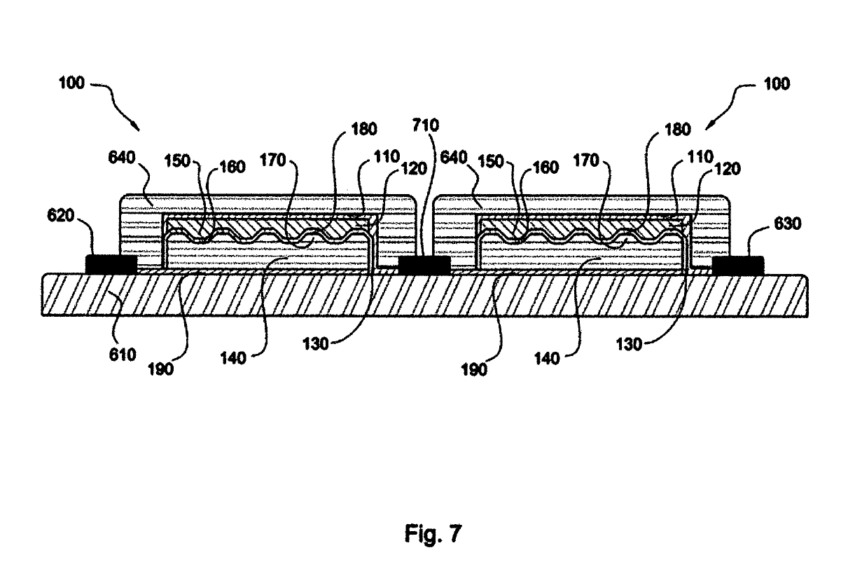

Referring now to FIG. 7, two or more thin-film batteries 100 may be fabricated on a common substrate 610. The embodiment shown in this figure includes two batteries 100 connected in series by a common terminal 710. Of course, in other embodiments batteries 100 fabricated on a substrate 610 may be connected in parallel and/or series configurations.

Referring now to FIG. 8, a perspective view of one embodiment of a battery 100 with a protective coating 640 consistent with the foregoing is shown.

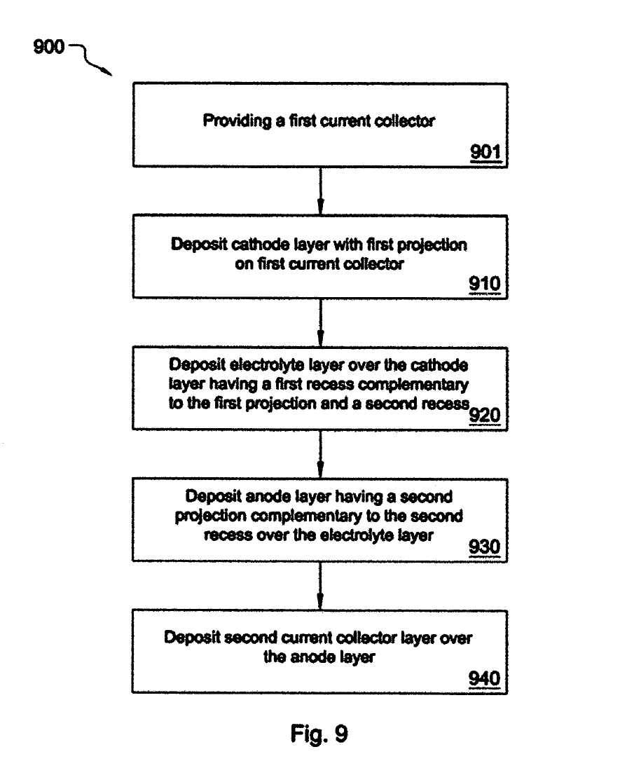

Referring now to FIG. 9, a method 900 of fabricating a battery comprises the steps of providing a first current collector and depositing 910 a cathode layer with a first projection on the first current collector. In at least one embodiment, the first current collector comprises nickel. Alternatively, the first current collector may comprise gold, copper, or aluminum. The first current collector may in some embodiments be deposited on a substrate.

As previously mentioned, the cathode layer may comprise a material such as lithium cobalt oxide (LiCoO2). Alternatively, it may comprise LiNiO₂, V₂O₅, TiS₂LiₓMn₂O₄, V₆O₁₃ or other cathode material known in the art. In some embodiments, the cathode layer may comprise a plurality of projections.

Layers such as the cathode layer in the battery may be deposited 910 on the first current collector by a three-dimensional printing or process. In three-dimensional printing, a CAD model of a three-dimensional part is used to fabricate the part one layer at a time. Since three-dimensional printing offers the flexibility of fabricating virtually any three-dimensional structure out of virtually any material, a three-dimensional printing process may enable the precise fabrication of the first projection as well as additional projections and/or three-dimensional shapes on the cathode layer. Additionally, a three-dimensional printing process permits the fabrication of a battery consistent with the invention directly on a circuit board in conjunction with printed circuit board production.

In other embodiments, deposition of layers may be achieved through the use of sputtering, evaporation, chemical vapor deposition, or combinations thereof.

The method 900 further comprises the step of depositing 920 a solid-state electrolyte layer over the cathode layer. The solid-state electrolyte layer comprises a first recess complementary to the first projection, thus increasing the surface area of the interface between the cathode layer and the solid-state electrolyte layer as has been previously mentioned. In embodiments where the cathode layer comprises a plurality of projections, the solid-state electrolyte layer may comprise a plurality of recesses complementary to the projections.

In some embodiments the solid-state electrolyte layer may comprise lithium phosphorus oxynitride (also known as “LiPON”). This solid-state electrolyte layer may also be deposited 920 using three-dimensional printing techniques. In such an embodiment, a different print head or nozzle may be used for the solid-state electrolyte layer than is used for the cathode layer or other layers to enable the printing of the entire battery in one printing session.

The method 900 additionally comprises the steps of depositing 930 an anode layer over the solid-state electrolyte layer. The anode layer comprises a second projection complementary to a second recess in the solid-state electrolyte layer. In some embodiments, the anode layer may comprise a plurality of projections complementary to a plurality of recesses in the solid-state electrolyte layer.

The anode layer may comprise lithium metal, tin nitride (SN₃N₄), or another anode material deemed suitable. In conjunction with the other layers, the anode layer may be deposited on the solid-state electrolyte layer through three-dimensional printing techniques, evaporation, sputtering, or combinations thereof.

Finally, the method 900 comprises the step of depositing 940 a second current collector layer over the anode layer. Like the first current collector layer, the second current collector layer may comprise nickel, gold, aluminum or another suitable electrical conductor.

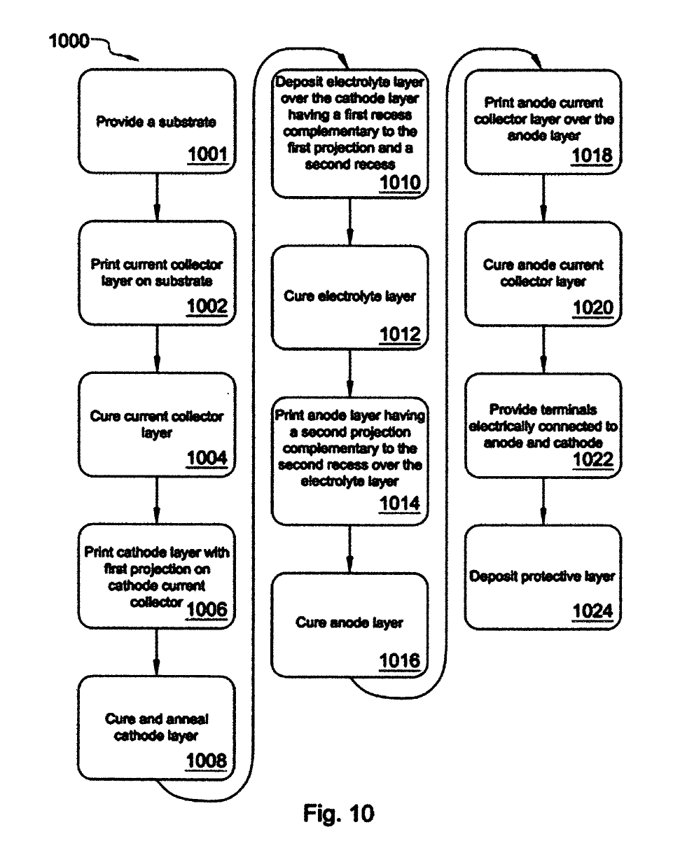

Referring now to FIG. 10, another embodiment of a method 1000 of fabricating a battery 100 incorporates three-dimensional printing together with localized curing and annealing of materials.

The method 1000 includes the step of providing 1001 a substrate. The substrate may be a polymide support substrate, a printed circuit board, or another substrate more suitable to the specific application. A first current collector layer is printed 1002 on the substrate. The first current collector layer may then be cured 1004. In at least one embodiment, the process of printing 1002 the first current collector layer may include printing a plurality of thin films of the current collector material until the first current collector layer has reached the desired thickness. In these embodiments, the curing 1004 may occur in-situ with a laser as each thin film is printed. In other embodiments the first current collector layer may be cured by heating it to a specified temperature (largely determined by the material being cured) for an appropriate amount of time.

A cathode layer with at least a first projection is printed 1006 over the first current collector layer. It has been shown in the art that annealing some cathode materials (i.e. LiCoO₂) may provide a preferable crystal orientation for ion transport and thus increase battery efficiency. The cathode layer may be cured and annealed 1008 either in-situ using a laser or with more conventional methods.

A solid-state electrolyte layer is deposited 1010 over the cathode layer. The solid-state electrolyte layer comprises a first recess complementary to the first projection and a second recess. In the event that the cathode layer comprises multiple projections the solid-state electrolyte layer may comprise multiple complementary recesses.

The solid-state electrolyte layer may be LiPON. Presently in the art, a LiPON layer is typically deposited by sputtering lithium orthophosphate in a nitrogen plasma over a cleaned and conditioned cathode layer. The lithium orthophosphate reacts with the nitrogen plasma to produce lithium phosphate oxynitride (LiPON). Although some embodiments of the invention may incorporate this form of deposition, other embodiments include the production of LiPON, it is believed that a LiPON solid-state electrolyte layer may be formed on the cathode layer by printing thin films of lithium orthophosphate and locally curing 1012 the lithium orthophosphate with a laser in the presence of nitrogen.

An anode layer is printed 1014 over the solid-state electrolyte layer. The anode layer comprises a second projection complementary to the second recess of the solid-state electrolyte layer. The anode layer may be cured 1016 either in-situ as part of the printing process or using more conventional means as has already been explained.

A second current collector layer is then printed 1018 over the anode layer. The second current collector layer may comprise nickel, gold, aluminum or another suitable conductor. The second current collector layer may then be cured 1020 by similar techniques as have been disclosed in relation to other layers.

Electrical terminals may be electrically connected to the cathode layer and the anode layer. In other embodiments, additional battery cells may be fabricated over the layers and connected in series or parallel and terminals may be electrically connected to at least one cathode layer and at least one anode layer. A protective coating such as parylene may be deposited 1024 over the layers. A portion of each of the terminals may extend beyond the protective coating to allow battery to connect to outside devices.

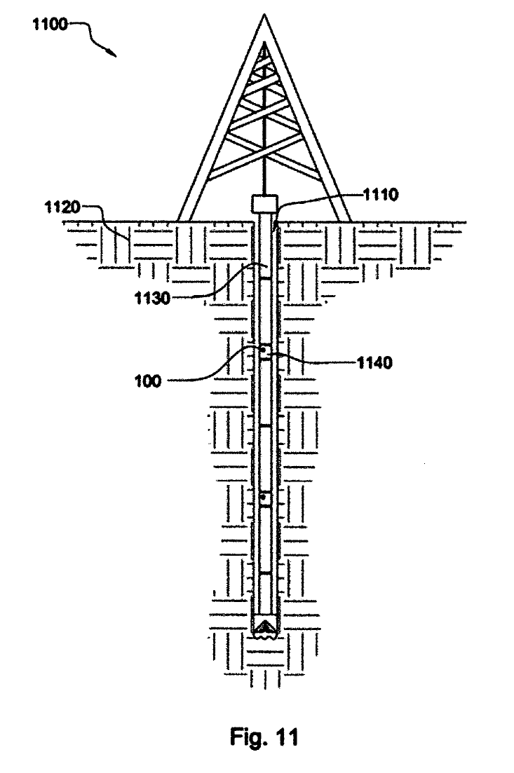

Referring now to FIG. 11, one application of the present invention is in downhole environments. Due to the use of solid-state electrolytes in place of the more commonly used liquid or paste electrolytes, thin-film batteries are able to operate at much higher temperatures than conventional batteries. A thin-film battery 100, especially one with increased ion-transport capacity according to the present invention, may be used in downhole environments for increased amounts of time and may be more efficient in its power delivery. One example of a downhole system 1100 incorporating the battery 100 of the present invention comprises a bore 1110 extending into a portion of the earth 1120. The bore 1110 may include a downhole tool string 1130 used for hydrocarbon or geothermal exploration or in a production well. A downhole device 1140 may be disposed within the bore 1110 or in an enclosure formed in the drill string 1130. The downhole device 1140 may be used in conjunction with or even coupled to the downhole tool string 1130 and comprises a battery 100 according to the invention.

The downhole device may be a networked device such as a repeater, an amplifier, a processor, a sensor, an automated tool, or a combination of the above. U.S. Pat. No. 6,670,880 to Hall discloses a downhole data transmission system that may be particularly compatible with a battery 100 of the present invention. In some embodiments, the battery 100 itself is connected to the network and is capable of providing power to a device connected to the network remotely.

The battery 100 of the downhole device 1140 has a cathode layer 140 deposited on a first current collector layer 190. The cathode layer 140 comprises at least a first projection 170. An anode layer 120 comprises at least a second projection 150. A solid-state electrolyte layer 130 is intermediate the cathode layer 140 and the anode layer 120. The solid-state electrolyte layer 130 comprises a first recess 180 complementary to the first projection 170 and a second recess 160 complementary to the second projection 150. A second current collector layer 110 is deposited over the anode layer 120.

Whereas the present invention has been described in particular relation to the drawings attached hereto, it should be understood that other and further modifications apart from those shown or suggested herein, may be made within the scope and spirit of the present invention.

What is claimed is:

1. A battery comprising:
a first current collector layer;
a cathode layer deposited on the first current collector layer and comprising a first projection;
an anode layer comprising a second projection;
a solid-state electrolyte layer intermediate the cathode layer and the anode layer, the solid-state electrolyte layer comprising a first recess complementary to the first projection and a second recess complementary to the second projection; and
a second current collector layer deposited over the anode layer.

2. The battery of claim 1, wherein the cathode layer comprises a plurality of projections.

3. The battery of claim 2, wherein the solid-state electrolyte layer comprises a plurality of recesses complementary to the projections of the cathode layer.

4. The battery of claim 1, wherein the anode layer comprises a plurality of projections.

5. The battery of claim 4, wherein the solid-state electrolyte layer comprises a plurality of recesses complementary to the projections of the anode layer.

6. The battery of claim 1, wherein the solid-state electrolyte layer comprises lithium phosophorus oxynitride.

7. The battery of claim 1, wherein the battery is rechargeable.

8. A method of fabricating a battery comprising:
providing a first current collector;
depositing a cathode layer comprising a first projection on the first current collector;
depositing an electrolyte layer over the cathode layer having a first recess complementary to the first projection;
depositing an anode layer over the electrolyte layer, the anode layer having a second projection complementary to a second recess in the electrolyte layer; and
depositing a second current collector layer over the anode layer.

9. The method of claim 8, wherein the at least one of the layers is deposited by three-dimensional printing.

10. The method of claim 8, further comprising the step of annealing the cathode layer.

11. The method of claim 10, wherein the cathode layer is annealed in-situ as it is deposited.

12. The method of claim 8, further comprising the step of curing at least one of the layers.

13. The method of claim 8, wherein the cathode and anode layers comprise a plurality of projections with complementary recesses in the electrolyte layer.

14. The method of claim 8, further comprising the step of providing positive and negative terminals electrically connected to the first current collector and the second current collector, respectively.

15. The method of claim 8, further comprising the step of depositing a protective coating over the second current collector and exposed portions of other layers.

16. A system comprising:
a bore extending into a portion of earth;
a downhole device disposed within the bore, the downhole device comprising a battery;
the battery comprising a cathode layer deposited on a first current collector layer and comprising a first projection, an anode layer comprising a second projection, a solid-state electrolyte layer intermediate the cathode layer and the anode layer, the solid-state electrolyte layer comprising a first recess complementary to the first projection and a second recess complementary to the second projection, and a second current collector layer deposited over the anode layer.

17. The system of claim 16, wherein the cathode layer comprises a plurality of projections.

18. The system of claim 17, wherein the solid-state electrolyte layer comprises a plurality of recesses complementary to the projections of the cathode layer.

19. The system of claim 16, wherein the anode layer comprises a plurality of projections.

20. The system of claim 16, wherein the solid-state electrolyte layer comprises a plurality of recesses complementary to the projections of the anode layer.

21. The system of claim 16, wherein the downhole device is coupled to a tool string.
